(19) United States
(12) Patent Application Publication
(10) Pub. No.: US 2013/0295360 A1
(43) Pub. Date: Nov. 7, 2013

(54) REINFORCING FABRIC, A CEMENTITIOUS BOARD, AND METHOD OF FORMING THE CEMENTITIOUS BOARD

(71) Applicants: Gabe F. Nagy, Holley, NY (US); Jie-yi Dong, Oakville (CA); Gary W. Morris, Niagara Falls (CA)

(72) Inventors: Gabe F. Nagy, Holley, NY (US); Jie-yi Dong, Oakville (CA); Gary W. Morris, Niagara Falls (CA)

(21) Appl. No.: 13/862,173

(22) Filed: Apr. 12, 2013

Related U.S. Application Data
(60) Provisional application No. 61/624,149, filed on Apr. 13, 2012.

(51) Int. Cl. B28B 23/02

(52) U.S. Cl. CPC B28B 23/02
USPC 428/219; 442/59; 442/72; 442/166; 442/171; 442/180; 442/164; 442/1; 442/5; 442/49; 428/220

(57) ABSTRACT

A reinforcing fabric for a cementitious board includes an alkali-resistant fabric and a binder including ethylene vinyl acetate. The cementitious board includes (a) a cementitious core; and (b) the reinforcing fabric disposed on at least one face of the cementitious core, the reinforcing fabric including the alkali-resistant fabric and the binder including ethylene vinyl acetate.

### CROSS-REFERENCE TO RELATED APPLICATION

The present application claims priority from U.S. Provisional Patent Application No. 61/624,149, filed Apr. 13, 2012, entitled “A REINFORCING FABRIC, A CEMENTITIOUS BOARD, AND METHOD OF FORMING THE CEMENTITIOUS BOARD,” naming inventors Gabe F. Nagy, Jie-yi Dong and Gary W. Morris, which application is incorporated by reference herein in its entirety.

### FIELD OF THE DISCLOSURE

This disclosure, in general, relates to a coated reinforcing fabric for cementitious boards.

### BACKGROUND

Cementitious boards useful in the construction industry are known to contain inorganic, hydraulically setting material, such as a modified cement or gypsum. Hydraulic gypsum and cement, once set, have very little tensile strength and are usually reinforced with facing materials which improve the resistance to tensile and flexural loads. This has been the basis for using paper facing on conventional gypsum wall board and non-woven glass fiber scrim in cement boards.

Glass fiber meshes have been popular as a facing sheet in cement boards because they can increase the dimensional stability in the presence of moisture and provide greater physical and mechanical properties. However, most glass fiber compositions, other than AR glass, degrade in the alkali environment of a cement core, so they must be coated with a protective finish.

Current glass scrim reinforcements typically include a coating of PVC plastisol, a blend of PVC particles dispersed in plasticizer (usually phthalate based). By necessity, such coatings contain heat stabilizers and varsol (or other paraffin oil based solvent) to control viscosity. Despite the presence of the heat stabilizer, it is not advisable to dry PVC at too high a temperature or it will de-polymerize. The phthalate plasticizer has also come under increased scrutiny for its possible toxicity. The solvent used to control viscosity also tends to evaporate during drawings and yields voids in the coating, leading to decreased alkali resistance in certain locations such that an alkaline environment will attack uncoated glass fiber surfaces.

As such, an improved reinforcing fabric for cementitious boards is desired.

### SUMMARY

In a particular embodiment, a reinforcing fabric for a cementitious board includes an alkali-resistant fabric and a binder including ethylene vinyl acetate.

In another exemplary embodiment, a cementitious board includes (a) a cementitious core; and (b) a reinforcing fabric disposed on at least one face of the cementitious core, the reinforcing fabric including an alkali-resistant fabric and a binder including ethylene vinyl acetate.

In another embodiment, a method of making a cementitious board includes (a) providing a reinforcing fabric including an alkali-resistant fabric and a binder including ethylene vinyl acetate; (b) depositing a cementitious slurry on the reinforcing fabric; and (c) forming the cementitious slurry and the reinforcing fabric into the cementitious board.

### BRIEF DESCRIPTION OF THE DRAWINGS

The present disclosure may be better understood, and its numerous features and advantages made apparent to those skilled in the art by referencing the accompanying drawings.

FIG. 1 includes a side cross-sectional view of an exemplary cementitious board showing an embedded reinforcing fabric.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

Before addressing details of the embodiments described below, some terms are defined or clarified. The term “degradation” is intended to mean a process or technique by which one or more properties of a product, such as a polymer- and/or glass-based product, is degraded under the influence of one or more environmental factors, such as exposure to heat, light, or chemicals. The term “ASTM” is intended to refer to the American Society for Testing and Materials (ASTM) Standard. The term “psi” is intended to refer to the measurement unit of pounds per square inch.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts.

Reinforcing fabrics, cementitious boards and methods of making cementitious boards having the reinforcing fabric are provided. The reinforcing fabric includes an alkali-resistant material and a binder. In a particular embodiment, the binder is a non-alkali-resistant material, such as a binder including an ethylene vinyl acetate. The alkali-resistant material in combination with the ethylene vinyl acetate containing binder provides a reinforcing fabric with desirable physical properties. Further, the reinforcing fabric provides an environmentally-green product.

The reinforcing fabric includes an alkali-resistant material. An “alkali-resistant material” as used herein refers to a material that provides resistance to an alkali environment without degradation of the reinforcing fabric. Any reasonable alkali-resistant material is envisioned. Exemplary alkali-resistant materials include a polyester, a polyvinyl alcohol, a polypropylene, a polyethylene, an alkali-resistant glass, or combination thereof. In a particular embodiment, the alkali-resistant material is a polyvinyl alcohol.

The alkali-resistant material may be in the form of a fiber, a yarn, chopped fibers, the like, or combinations thereof. The term “fiber” as used herein refers to filamentary materials. Often, “fiber” is used synonymously with “filament”. The term “filament” is intended to mean an elongated structure or fiber of any suitable length. It is generally accepted that a filament routinely has a finite length that is at least 100 times its diameter. In most cases, it is prepared by drawing the alkali-resistant material from a molten bath, spinning, or by deposition on a substrate. In a particular embodiment, the fibers are assembled into a yarn which may be generally described as an assemblage of twisted filaments, fibers, or strands, either natural or manufactured, to form a continuous length that is suitable for use in weaving or interweaving into textile materials. In another embodiment, the fibers are provided at any length envisioned suitable for use in a non-woven configuration.

Any assembly of the alkali-resistant material into an alkali-resistant fabric is envisioned. In an embodiment, the alkali-resistant material may be formed into the alkali-resistant fabric in the form of a scrim, a woven mat, a non-woven mat, a braided fabric, a knitted fabric, a chopped strand, or combination thereof. A “chopped strand” typically describes randomly oriented chopped filaments or fibers, wherein the chopped filaments or fibers are randomly oriented individually or in a group. In an embodiment, a “non-woven mat” may have filaments, fibers, or swirled continuous filament that are randomly-oriented or oriented in a specified configuration. A “knitted fabric” typically includes fabrics produced by interloping chains of filaments, roving, or yarn. In a particular embodiment, the alkali-resistant fabric is in the form of a scrim. The term “scrim” is intended to mean a woven or nonwoven fabric that includes at least two filaments oriented in two different directions, including but not limited to a mesh. A scrim may also be known as a “laid-scrim” and describes a fabric that is non-woven with warp yarns and weft yarns. The term “laid scrim” is intended to mean a scrim in which at least one filament overlies at least one other filament to create the scrim. The term “mat” is intended to mean a woven or nonwoven fabric that includes any suitable arrangement of filaments other than an arrangement of filaments in a scrim, including an arrangement of randomly oriented filaments. A “woven mat” describes a fabric have warp yarns and weft yarns that are intertwined at an intersection point. The warp yarns refer to yarns, fibers, or roving running lengthwise in long lengths and approximately parallel. The weft yarns refer to the threads that transverse the warp yarns. In a particular embodiment, the weft yarns run perpendicular to the warp and are also called fill, filling, yarn or woof. In a particular embodiment, the alkali-resistant fabric includes at least one yarn of a polyvinyl alcohol in the warp direction. In a more particular embodiment, the alkali-resistant fabric includes at least one yarn of a polyvinyl alcohol, at least one yarn of polyethylene, at least one yarn of polyester, or combination thereof in the weft direction. The alkali-resistant material may be converted to fabric form by a conventional weaving operation, such as a loom, or a non-weaving operation.

Any other construction can also be envisioned for the alkali-resistant fabric. In an embodiment, constructions include stitchbonding or warp knitting. Any conventional means include plain weaving, twill or satin weaving, unidirectional weaving, knitting or stitchbonding. In an embodiment, fine-fiber strands of yarn from the forming operation can be air dried on forming tubes to provide sufficient integrity to undergo a twisting operation. Twist provides additional integrity to yarn before it is subjected to the weaving process. Any twist is envisioned. A typical twist includes up to about 0.7 turns/inch to about 1.0 turns/inch. In many instances, heavier yarns may be used for the weaving operation. This is normally accomplished by twisting together two or more single strands, followed by a plying operation. Plying typically includes retwisting the twisted strands in the opposite direction from the original twist. Any type of twist is envisioned. The two types of twist normally used are known as S and Z, which indicate the direction in which the twisting is done. Typically, two or more strands twisted together with an S twist are plied with a Z twist in order to give a balanced yarn. Thus, the yarn properties, such as strength, bundle diameter, and yield, can be manipulated by the twisting and plying operations. Zero twist-yarns may also be used. This input can offer the ease of spreading of (twistless) roving with the coverage of fine-filament yarns.

The major characteristics of the knit or woven embodiments of this invention include its style or weave pattern, fabric count, and the construction of warp yarn and weft yarn. As used here, “fabric count” identifies the number of warp and weft yarns per inch. In combination, these major characteristics contribute to the fabric properties such as drapability and performance of the final board.

Prior to coating, the alkali-resistant fabric has a desirable areal weight. For instance, the areal weight is about 15 grams/m² to about 300 grams/m², such as about 30 grams/m² to about 150 grams/m². In an embodiment, the alkali-resistant fabric has a thickness of about 5 mils to about 22 mils, such as about 10 mils to about 15 mils prior to coating. The linear density of fibers of the alkali-resistant fabric is typically about 50 tex where yarns are employed, to about 2,500 tex where rovings are employed. In an embodiment, the alkali-resistant fabric may also possess an ASTM D309 tensile strength of at least about 50 pounds per inch (lbs/in), such as at least about 85 pounds per inch to about 95 pounds per inch, such as at least about 100 pounds per inch to about 130 pounds per inch, or even greater in the machine direction and in the cross-machine direction.

The reinforcing fabric includes a binder to adhere the alkali-resistant fabric. Due to the alkali-resistant properties of the fabric, a non-alkali resistant material may be used as the binder. Any reasonable non-alkali resistant binder is envisioned. “Non-alkali resistant” as used herein refers to a material that is not inherently resistant to an alkali environment. In a particular embodiment, the binder includes ethylene vinyl acetate. The binder is present on the alkali-resistant fabric in an amount to bind the alkali-resistant fabric and form the reinforcing fabric. Any reasonable amount of ethylene vinyl acetate is present in the binder, such as at least about 1.0 weight %, such as at least about 5.0 weight %, such as at least about 10.0 weight %, or even greater, based on the total weight of the binder composition. In an embodiment, the binder may be coated on individual strands of fiber, filaments, or yarn. In an embodiment, the binder coats the front surface, the back surface, or combination thereof of the alkali-resistant fabric. In an embodiment, the binder coats a combination of both the front surface and the back surface of the alkali-resistant fabric. In a particular embodiment, the alkali-resistant material is coated with the binder without any exposed surface of the alkali-resistant material. In a more particular embodiment, the binder provides a homogenous, continuous coating on the alkali-resistant fabric without any exposed surface of the alkali-resistant material. For instance, the binder is present at an amount of about 30% by weight to about 100% by weight of the total weight % of the reinforcing fabric, such as about 40% by weight to about 70% by weight of the total weight of the reinforcing fabric. Typically, the binder is coated on the alkali-resistant fabric at any reasonable thickness. In an embodiment, the thickness of the alkali-resistant fabric with the binder coating is about 0.008 inch to about 0.018 inch, such as about 0.010 inch to about 0.012 inch.

Additionally, the binder can be provided with any reasonable additive. Exemplary additives include viscosity modifiers, additives for improved heat resistance, defoaming, re-wetting agents, mold inhibitors, fire retardants, coloring agents, and the like. Any reasonable amount of additive is envisioned. In an embodiment, additives to the binder can promote greater affinity to set gypsum, or to modified cement-based mortars, for example. For instance, the binder can include an aqueous based polymer such as an acrylic, a styrene butadiene rubber, a vinyl chloride copolymer, the like, or combinations thereof to provide desirable adhesion to the gypsum or to a modified cement based mortar. In a particular embodiment, the binder can include a water-based vinyl chloride copolymer. For instance, the binder includes ethylene vinyl acetate and a water-based vinyl chloride copolymer. Any reasonable amount of aqueous based polymer, such as the water-based vinyl chloride copolymer is envisioned, such as up to about 50.0 weight %, such as up to about 60.0 weight %, such as up to about 70.0 weight %, such as up to about 80.0 weight %, such as up to about 90 weight %, or even up to about 95 weight % of the total weight % of the binder composition.

In an embodiment, the binder is substantially free of additives. In a particular embodiment, the binder is substantially free of a PVC plastisol, a solvent, a plasticizer, or combinations thereof. In a more particular embodiment, the binder composition is substantially free of a phthalate plasticizer, typically required in a conventional PVC plastisol coating for flexibility. “Substantially free” as used herein refers to less than about 0.01 weight % of the total weight % of the binder composition.

The binder can be applied to the alkali-resistant fabric by any reasonable method. The alkali-resistant fabric may be coated with the binder before forming the reinforcing fabric (i.e. by coating the alkali-resistant film, filament, or yarn), in-line concurrently with formation of the reinforcing fabric, or off-line coating after formation of the reinforcing fabric. In an embodiment, the binder can be applied in at least one layer or at least one pass. The number of layers or passes of the binder typically depends on the material chosen for the alkali-resistant fabric as well as its construction. The number of applications of the binder may be dependent upon the desired amount of coating to provide a reinforced fabric. Furthermore, the number of applications of the binder may be dependent on the desired porosity for the final reinforcing fabric. Typically, a high porosity may be desired to aid in the embedding of the reinforcing fabric in the cementitious board. Subsequent layers of the binder to reduce porosity may not be necessary except in the case where a very smooth surface of the cementitious board is desired. “Porosity” as used herein may be dependent upon the intersections of the yarns to allow for openings between the spacing of the yarns as well as dependent on the amount of binder applied on the yarns. For instance, less spacing between the yarns provides lower porosity compared to greater spacing between the yarns.

In an embodiment, the reinforcing fabric may have an optional coating to impart further properties to the reinforcing fabric. In a particular embodiment, the optional coating may provide, for example, reduced porosity, increased adhesion to the cementitious material, resistance to slurry penetration, reduced corrosion, improved strength or fire resistance, reduced water resistance, reduced “fuzziness” of the surface, or any combination thereof. The optional coating is distinguished from the binder used to bond the alkali-resistant material together but may be the same or different composition. Any reasonable composition for the optional coating is envisioned. In an embodiment, the optional coating may be a resinous mixture containing one or more resins. For instance, the rein may be a thermoplastic resin or a thermoset resin. In a particular embodiment, the optional coating may include a UV stabilizer, a mold retardant, an alkali-resistant formulation, a water repellant, a flame retardant, a dispersant, a catalyst, a filler, the like, and combinations thereof. The optional coating can be applied to the reinforcing fabric before and/or after joining to the cementitious core.

The reinforcing fabric is a facing material which may be embedded within a cementitious layer as to present a fibrous surface embedded totally, or only partially, on at least one face of a cementitious board. Any cementitious material is envisioned for the cementitious layer. The cementitious layer typically includes a cementitious matrix material, such as cement paste, mortar or concrete, and/or other types of materials such as gypsum, geopolymers (inorganic resins), and geotextiles. In an embodiment, the cementitious material includes gypsum. If gypsum is used, the material may be formed by mixing water with powdered anhydrous calcium sulfate or calcium sulfate hemidrate (Ca—SO₄1/2H₂0), also known as calcined gypsum, to form a slurry and thereafter allowing the slurry to set into calcium sulfate dihydrate (CaSO₄2H₂0), a relatively hard material. The cementitious material of the cementitious board will in general include at least about 85 weight % set gypsum or cement, based on the total weight % of the cementitious material.

In an embodiment, the cementitious material further includes at least one additive that improves the performance of the resulting cementitious board. Additives include chopped fibers dispersed throughout the cement. In an embodiment, the chopped fibers are AR-glass fibers but may also include, for example, other types of glass fibers, aramids, polyolefins, carbon, graphite, polyester, PVA, polypropylene, natural fibers, cellulosic fibers, rayon, straw, paper and hybrids thereof. The cementitious material may include other ingredients or additives such as, for example, fly ash, latex, slag and metalcaolin, resins, such as acrylics, polyvinyl acetate, or the like, ceramics, including silicon oxide, titanium oxide, and silicon nitrite, setting accelerators, water and/or fire resistant additives, such as silioxane, borax, fillers, setting retardants, dispersing agents, dyes and colorants, light stabilizers and heat stabilizers, shrinkage reducing admixtures, air entraining agents, setting accelerators, defoaming agents, or combinations thereof. In an embodiment, the cementitious material may contain curing agents. In an embodiment, materials that improve the water-resistant properties of the cementitious product are also included.

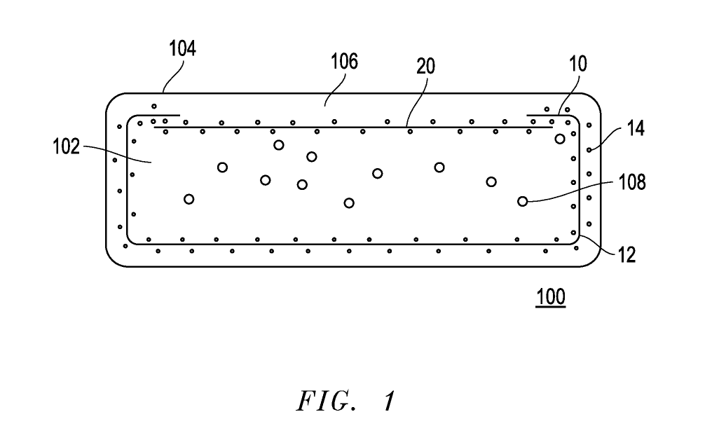

As seen in FIG. 1, a cementitious board 100 is provided, including a cementitious core 102, a reinforcing fabric 10, and a separate reinforcing fabric 20. The surface 104 of the cementitious core 102 is faced with one or more layers of the reinforcing fabric 10 and separate reinforcing fabric 20. Any number of layers of reinforcing fabric 10 and separate reinforcing fabric 20 is envisioned. Although not illustrated, a single reinforcing fabric 10 may be used that reinforces an entire perimeter of the cementitious board 100.

In the illustrated embodiment, the reinforcing fabric 10 includes warp yarns 12 and weft yarns 14 in a laid scrim with the binder including an ethylene vinyl acetate. The reinforcing fabric 10 and separate reinforcing fabric 20 may be the same or a different material. In a particular embodiment, the reinforcing fabric 10 and the separate reinforcing fabric are the same material. In an embodiment, a thin cementitious layer 106 is on the surface 104 of the cementitious board 100. The cementitious core 102 can further include performance additives 108 which can be added to the slurry precursor of the cementitious core 102.

Any method of manufacturing the cementitious board 100 is envisioned, including molding, extrusion, and semi-continuous processes. Typically, the cementitious board 100 can be made by forming an aqueous cementitious slurry which contains excess water and placing the cementitious slurry on the facing material, such as reinforcing fabric 10. The reinforcing fabric 10 may be folded around the perimeter of the cementitious board 100 before final setting of the cementitious core 102. Folding can be accomplished by any reasonable method such as a combination of guide flanges and rollers which embed the reinforcing fabric 10 within the board 100. Furthermore, separate reinforcing fabric 20 may be disposed within the aqueous cementitious slurry before final setting of the cementitious core 102. Aided by heating, excess water evaporates through the reinforcing fabric 10 and separate reinforcing fabric 20 as the slurry sets. In an embodiment, heating may be at any reasonable temperature to evaporate the water contained within the slurry. For instance, the heating may occur at temperatures of about 280° F. to about 350° F. The dwell time the material is exposed to at those temperatures typically varies, depending on the machine used. In an example, the dwell time is about 30 seconds to about 120 seconds. In an embodiment, the reinforcing fabric 10 and separate reinforcing fabric 20 should be at least be sufficiently porous to permit water in the aqueous slurry from which the core is made to evaporate therethrough, and may be porous enough to permit the slurry to pass through and form a continuous or discontinuous film. In an exemplary embodiment, the reinforcing fabric 10 and separate reinforcing fabric 20 are hydrophilic, attracting water away from the cementitious core 102.

The reinforcing fabric provides a board product with advantageous properties such as desirable alkali resistance, tensile strength, and modulus of rupture. In an embodiment, the reinforcing fabric provides a cementitious board with a desirable deflection at break. For instance, the reinforcing fabric provide a deflection at break that is at least two to five times greater than a commercially available glass-based cement board scrim having a polyvinyl chloride (PVC) plastisol binder. In an embodiment, the deflection at break is at least about 0.4 inches as measured by ASTM C947-89. In an embodiment, the tensile strength is at least about 85 psi. In an embodiment, the modulus of rupture is at least about 600 psi. Further, the reinforcing fabric has a Gurley Stiffness measurement such that the reinforcing fabric is sufficiently drapable and lacking in shape memory so as to be curved around the edge of a product to be reinforced, such as a gypsum board or a cement board, during manufacture of the same.

Applications for the reinforcing fabric are numerous. In particular, the non-toxic nature of the ethylene vinyl acetate (EVA) containing binder makes the material useful for any application where toxicity is undesired. For instance, the binder containing ethylene vinyl acetate does not produce volatile organic compounds compared to a typical PVC plastisol binder. The reinforcing fabric can be employed in many end-use reinforcement applications, such as, for example, gypsum and cement boards, asphalt and road reinforcement, roofing applications, soil reinforcement, polymer-matrix reinforcement, and as stand-alone coated fabrics in filters, screens and garment applications.

In a particular embodiment, the reinforcing fabric and cementitious board of this invention are useful in all sorts of building construction applications. They are strong, having a screw strength of at least about 20 lbs., for gypsum cores of conventional densities and compositions. Some examples include shaft wall assemblies for elevators and stairways, fire doors and fire walls, roofing and siding substrates, with or without insulation, exterior stucco systems, and tile backer boards. Some of the most desirable and useful applications for this invention are in EIF systems (also called EIFS, for Exterior Insulation Finishing Systems), or as tile backer boards.

### EXAMPLES

Two exemplary reinforcing fabric scrims are formed. Sample 1 has 1000 denier (1000D) PVA yarn in the machine direction (MD) and the cross direction (CD). Sample 2 has 1000 denier (1000D) PVA yarn in the machine direction and 2000 denier (2000D) PET yarn in the cross direction. The coating includes ethylene vinyl acetate with coating levels at about 60 wt. % based on the total weight of the reinforcing fabric (High DPU in Tables 1-10). “DPU” as used herein refers to dry pick up, i.e. the weight of the binder on the yarn referenced as a percentage of the overall dry fabric weight. Results can be seen in the following Tables.

TABLE 1
Sample 1 of 1″ Tensiles

| High DPU | High DPU | High DPU | High DPU |
|---|---|---|---|
| MD T0 | CD T0 | MD T1 | CD T1 |
| 95.81 pounds | 95.17 pounds | 100.71 pounds | 97.64 pounds |

TABLE 2
Sample 2 of 1″ Tensiles

| High DPU | High DPU | High DPU | High DPU |
|---|---|---|---|
| MD T0 | CD T0 | MD T1 | CD T1 |
| 99.85 pounds | 133.15 pounds | 99.18 pounds | 121.41 pounds |

With Tables 1 and 2, T0 is an as-made product tensile and the T1 is a 24 hour soak in an alkali-solution, dried for 24 hours and tested. Tensile is tested via industry standard. Clearly, there is no degradation in either Sample 1 or Sample 2 after a 24 hour alkali soak. Accordingly, the product is stable when exposed to an alkali solution.

TABLE 3
Sample 1 Claw bond test.

| High DPU MD | High DPU CD |
|---|---|
| 2.958 pounds | 2.636 pounds |

TABLE 4
Sample 2 Claw bond test.

| High DPU MD | High DPU CD |
|---|---|
| 4.923 pounds | 4.701 pounds |

Claw bond test shows the bond between the MD yarn and the CD yarn. One side of the yarn is held stationary while the other side is pulled to measure the bond at the intersection of the CD and MD yarn. Both samples show a sufficient strength between the MD and the CD.

Notably, Sample 2 having the 2000D polyester yarn has a great surface area at the intersection point between the MD and the CD than Sample 1, hence the strength at the intersection point for Sample 2 increases compared to Sample 1.

TABLE 5
Sample 1 Modulus of Rupture (MOR), ASTM C947-89

| | High DPU MD | High DPU CD |
|---|---|---|
| T3 (3 day) | 875 psi | 788 psi |
| T14 (14 day) | 706 psi | 755 psi |
| T28 (28 day) | 777 psi | 805 psi |

TABLE 6
Sample 2 Modulus of Rupture, ASTM C947-89

| | High DPU MD | High DPU CD |
|---|---|---|
| T3 | 782 psi | 811 psi |
| T14 | 731 psi | 729 psi |
| T28 | 698 psi | 699 psi |

With Tables 5 and 6, Samples 1 and 2 are placed in a cementitious material containing haydite and soaked in a heated hot water bath for 3 days (T3), 14 days (T14), and 28 days (T28). Clearly, the modulus of rupture demonstrates a stable material for both Samples.

TABLE 7
Sample 1 Break Deflection, ASTM C947-89

| | High DPU MD | High DPU CD |
|---|---|---|
| T3 | 0.759 inch | 0.794 inch |
| T14 | 0.776 inch | 0.674 inch |
| T28 | 0.583 inch | 0.474 inch |

TABLE 8
Sample 2 Break Deflection, ASTM C947-89

| | High DPU MD | High DPU CD |
|---|---|---|
| T3 | 0.938 inch | 1.188 inch |
| T14 | 0.779 inch | 0.732 inch |
| T28 | 0.705 inch | 0.433 inch |

For Tables 7 and 8, the break deflection is the peak measured during the modulus of rupture test. Typically, 0.2 inch to 0.3 inch are commercially acceptable minimum values. Clearly, the break deflection of the above Samples are much greater than commercially acceptable the minimum values.

TABLE 9
Sample 1 2″ Wide Tensiles

| | MD | CD |
|---|---|---|
| High DPU T0 | 199.13 pounds | 194.95 pounds |
| High DPU DiBT | 160.26 pounds | 179.40 pounds |
| High DPU ETAG | 190.40 pounds | 191.54 pounds |

TABLE 10
Sample 2 2″ Wide Tensiles

| | MD | CD |
|---|---|---|
| High DPU T0 | 178.98 pounds | 262.68 pounds |
| High DPU DiBT | 183.97 pounds | 265.43 pounds |
| High DPU ETAG | 194.71 pounds | 266.73 pounds |

For Tables 9 and 10, “DiBT” is a test wherein the Samples are immersed in a trialkali solution at an elevated temperature for six hours, removed from solution, air dried for 24 hours, and tensile tested. “ETAG” tests are at room temperature test in a trialkali solution. The material is placed in solution for 28 days, removed, rinsed with water, air dried for 48 hours, and tensile tested. Comparatively, the tensiles showed an increase, such that there is no degradation of the material throughout the testing.

From the foregoing, it can be realized that the binder provides an improved reinforcing fabric. In particular, the ethylene vinyl acetate containing binder enables a uniform coating to be applied to a knitted, braided, non-woven mesh-type, woven fabric, or chopped fabric. In particular, the ethylene vinyl acetate containing binder provides equal or better performance than plastisol coated laid scrim with similar drapability and lack of shape memory so as to be curved around the edge of a cement board or gypsum wall board. The ethylene vinyl acetate containing binder produces far fewer VOCs compared to a typical PVC plastisol binder. For instance, a typical PVC plastisol binder has VOCs of about 5.0 weight % to about 12.0 weight %, based on the total weight of the dried binder on an alkali resistant fabric and the ethylene vinyl acetate containing binder has VOCs less than about 0.5 weight %, based on the total weight of the dried binder on an alkali resistant fabric. The ethylene vinyl acetate containing binder does not contain any plasticizer. Furthermore, much less ethylene vinyl acetate containing binder is needed compared to a typical PVC plastisol binder.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A reinforcing fabric for a cementitious board comprising an alkali-resistant fabric and a binder comprising an ethylene vinyl acetate.

2. A reinforcing cementitious board comprising:
(a) a cementitious core; and
(b) a reinforcing fabric disposed on at least one face of the cementitious core; the reinforcing fabric comprising an alkali-resistant fabric and a binder comprising an ethylene vinyl acetate.

3. A method of making a cementitious board comprising:
(a) providing a reinforcing fabric comprising an alkali-resistant fabric and a binder comprising an ethylene vinyl acetate;
(b) depositing a cementitious slurry on the reinforcing fabric; and
(c) forming the cementitious slurry and the reinforcing fabric into the cementitious board.

4. The reinforcing fabric of claim 1, wherein the binder is present at about 30 weight % to about 100 weight % of the total weight % of the reinforcing fabric.

5. (canceled)

6. The reinforcing fabric of claim 1, wherein the alkali-resistant fabric comprises a polyester, a polyvinyl alcohol, a polypropylene, an alkali-resistant glass, or combination thereof.

7. The reinforcing fabric of claim 1, wherein the alkali-resistant fabric comprises a scrim, a woven mat, a non-woven mat, a braided fabric, a knitted fabric, a chopped strand, or combination thereof.

8. The reinforcing fabric of claim 7, wherein the alkali-resistant fabric comprises a scrim including at least one yarn of a polyvinyl alcohol in the warp direction.

9. The reinforcing fabric of claim 7, wherein the alkali-resistant fabric comprises a scrim including at least one yarn of a polyvinyl alcohol, at least one yarn of a polyester, or combination thereof in the weft direction.

10. The reinforcing fabric of claim 1, wherein the binder coats a front surface, a back surface, or a combination thereof of the alkali-resistant fabric.

11. The reinforcing fabric of claim 1, wherein the alkali-resistant fabric has an areal weight of about 15 grams/m² to about 300 grams/m².

12. The reinforcing fabric of claim 1, wherein the alkali-resistant fabric has a thickness of about 5 mils to about 22 mils without the binder.

13. The reinforcing fabric of claim 1, wherein the alkali-resistant fabric and binder has a thickness of about 0.008 inch to about 0.018 inch.

14. The reinforcing fabric of claim 1, having a deflection at break of at least about 0.4 inches as measured by ASTM C947-89.

15. The reinforcing fabric of claim 1, having a tensile strength of at least about 85 psi.

16. The reinforcing fabric of claim 1, having a modulus of rupture (MOR) of at least about 600 psi.

17. The reinforcing fabric of claim 1, wherein the binder is substantially free of a PVC plastisol, a solvent, a phthalate plasticizer, or combination thereof.

18. (canceled)

19. The reinforcing fabric of claim 1, wherein the binder comprises a vinyl chloride copolymer.

20. The reinforcing fabric of claim 1, wherein the reinforcing fabric is hydrophilic.

21. The reinforcing fabric of claim 1, wherein the reinforcing fabric is disposed at on least one face of a cementitious core.

22. (canceled)

23. The method of making the cementitious board of claim 3, further comprising heating the cementitious slurry to provide a set cement.
